(19) United States
(12) Patent Application Publication
(10) Pub. No.: US 2026/0100377 A1
(43) Pub. Date: Apr. 9, 2026

(54) ELECTRODE STRUCTURE, BATTERY AND METHOD OF MANUFACTURING ELECTRODE STRUCTURE

(71) Applicants: National Taiwan University of Science and Technology, TAIPEI CITY (TW); University of Münster, Münster (DE)

(72) Inventors: Yu-Ting WENG, New Taipei City (TW); Nae-Lih WU, Taipei City (TW); Bing-Joe HWANG, TAIPEI CITY (TW); Martin WINTER, Münster (DE); Placke TOBIAS, Münster (DE)

(21) Appl. No.: 19/056,712

(22) Filed: Feb. 18, 2025

(30) Foreign Application Priority Data
Oct. 4, 2024 (TW) 113138007

(51) Int. Cl. H01M 4/62; C08G 65/40; H01M 4/131; H01M 4/133; H01M 4/36; H01M 4/525; H01M 4/587

(52) U.S. Cl. CPC H01M 4/628; C08G 65/4068; H01M 4/131; H01M 4/133; H01M 4/366; H01M 4/525; H01M 4/587; H01M 4/625

(57) ABSTRACT

A electrode structure is provided in some embodiments of the present disclosure, including an electrode active material particle and an electrode coating layer. The electrode coating layer covers the positive electrode, in which the electrode coating layer includes a structure of formula 1,

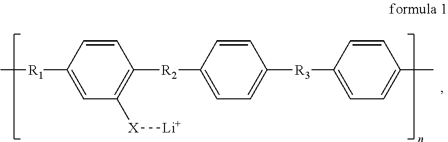

in which R₁ is oxygen, sulfur, ketone group or hydrocarbon group, R₂ is oxygen, sulfur, ketone group or hydrocarbon group, R₃ is oxygen, sulfur, ketone group or hydrocarbon group, and X is sulfonic acid group.

### CROSS-REFERENCE TO RELATED APPLICATION

This application claims priority to Taiwan Application Serial Number TW 113138007, filed Oct. 4, 2024, which is herein incorporated by reference.

### BACKGROUND

### Field of Invention

Some embodiments of the present disclosure provide an electrode structure, a battery and a method of manufacturing an electrode structure.

### Description of Related Art

Lithium-Ion Battery (LIB) is widely used due to its advantages such as high energy density, high output voltage, and low self-discharge rate.

However, when the battery undergoes repeated charge and discharge cycles, there may be a problem of cracking of the positive electrode caused by stress arising from crystal lattice deformation. Additionally, in the negative electrode, there is also a problem that lithium ions in the electrolytic solution are easily electroplated on the negative electrode, or solid impurities generated by the reaction of the electrolytic solution are formed on the negative electrode. The aforementioned problems will decrease capacity, charge and discharge efficiency, and battery stability during charge and discharge cycles.

Therefore, how to improve capacity, charge and discharge efficiency, and battery stability during charge and discharge cycles is a problem that needs to be solved.

### SUMMARY

Some embodiments of the present disclosure provide an electrode structure, include an electrode active material particle and an electrode coating layer. The electrode coating layer covers the electrode active material particle, in which the electrode coating layer includes a structure of formula 1,

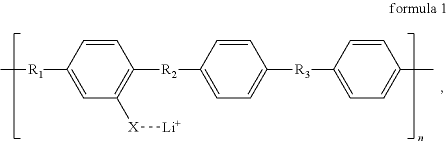

in which R₁ is oxygen, sulfur, ketone group or hydrocarbon group, R₂ is oxygen, sulfur, ketone group or hydrocarbon group, R₃ is oxygen, sulfur, ketone group or hydrocarbon group, and X is sulfonic acid group.

In some embodiments, a weight percentage of the electrode coating layer is from 0.1% to 5% based on 100% by a total weight percentage of the electrode active material particle and the electrode coating layer.

In some embodiments, the electrode active material particle includes Li, Ni, Co, Mn, or a combination thereof, or includes graphite.

In some embodiments, a total weight percentage of Li, Ni, Co, Mn, or a combination thereof is from 70% to 99% based on 100% by weight percentage of the electrode active material particle and the electrode coating layer.

In some embodiments, the electrode structure further includes an electrode conductive additive and an electrode binder.

In some embodiments, a weight percentage of the electrode conductive additive is from 1% to 15% and a weight percentage of the electrode binder is from 1% to 15% based on 100% by weight percentage of the electrode active material particle and the electrode coating layer.

In some embodiments, the electrode coating layer includes a structure of formula 2 as follows:

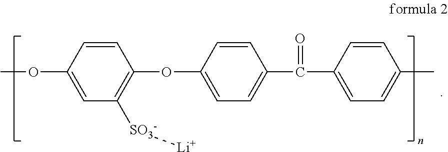

Some embodiments of the present disclosure provide a battery, including the abovementioned electrode structure, another electrode structure and an electrolytic solution. The electrolytic solution electrically connects via ionic conduction the electrode structure and the another electrode structure.

In some embodiments, the another electrode structure includes another electrode active material particle and another electrode coating layer. The another electrode coating layer covers the another electrode active material particle, in which the another electrode coating layer includes the structure of formula 1.

In some embodiments, a weight percentage of the another electrode active material particle is from 0.1% to 5% based on 100% by total weight percentage of the another electrode active material particle and the another electrode coating layer.

In some embodiments, the electrode active material particle in the electrode structure includes Li, Ni, Co, Mn, or a combination thereof, and the another electrode active material particle includes a carbon material particle.

In some embodiments, a weight percentage of the carbon material particle is from 70% to 99% based on 100% by weight percentage of the another electrode active material particle and the another electrode coating layer.

In some embodiments, the carbon material particle includes graphite.

In some embodiments, the another electrode structure further includes an another electrode conductive additive and an another electrode binder.

In some embodiments, a weight percentage of the another electrode conductive additive is from 1% to 15% and a weight percentage of the another electrode binder is from 1% to 15% based on 100% by weight percentage of the another electrode active material particle and the another electrode coating layer.

In some embodiments, the electrolytic solution includes lithium ions.

Some embodiments of the present disclosure provide a method of manufacturing an electrode structure, including: providing an electrode active material particle; providing a coating layer material, in which the coating layer material includes a structure of formula 1:

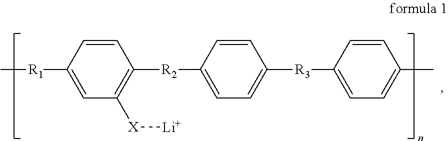

in which R₁ is oxygen, sulfur, ketone group or hydrocarbon group, R₂ is oxygen, sulfur, ketone group or hydrocarbon group, R₃ is oxygen, sulfur, ketone group or hydrocarbon group, and X is sulfonic acid group; mixing the electrode active material particle and the coating layer material in a polar solvent to obtain an electrode mixture; and heating the electrode mixture to remove the polar solvent and obtain an electrode structure, in which the electrode structure includes the electrode active material particle and an electrode coating layer covering the electrode active material particle.

In some embodiments, the step of mixing the electrode active material particle and the coating layer material in the polar solvent includes mixing the electrode active material particle and the coating layer material in a weight ratio of from 95:5 to 99.9:0.1.

In some embodiments, the coating layer material includes a structure of formula 2 as follows,

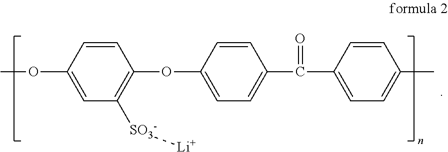

In some embodiments, the polar solvent includes N,N-dimethylacetamide (DMAc).

It is to be understood that both the foregoing general description and the following detailed description are examples and are intended to provide further explanation of the present disclosure as claimed.

### BRIEF DESCRIPTION OF THE DRAWINGS

In order to allow the above-mentioned and other purposes, features, advantages and embodiments of the present disclosure to be more clearly understood, accompanying drawings are described as follows:

FIG. 1 is a flow chart of a method of manufacturing an electrode structure according to some embodiments of the present disclosure.

FIG. 2A illustrates the electrode structure in the field of view of a transmission electron microscope when SPEEK-Li is used as the electrode coating layer (the electrode active material particle is NCM811) in an embodiment of the present disclosure.

FIG. 2B illustrates the negative electrode structure in the field of view of the transmission electron microscope when SPEEK-Li is used as the negative electrode coating layer (the electrode active material particle is graphite) in an embodiment of the present disclosure.

FIG. 3 illustrates the test results of the indentation test on the electrode structure in an embodiment of the present disclosure.

FIG. 4A illustrates the relationship between normalized fully-charging capacity ratio and charging time of each group of the negative electrode structures when different polymers are used as the negative electrode coating layer in an embodiment of the present disclosure.

FIG. 4B illustrates the relationship between specific lithiation capacity and cycle number of each group of the negative electrode structures during the multiple charge and discharge cycles when different polymers are used as the negative electrode coating layer in an embodiment of the present disclosure.

FIG. 5A illustrates the relationship between normalized fully-charging capacity ratio and charging time of each group of the negative electrode structures when different weight percentages of SPEEK-Li are used as the another electrode coating layer of the graphite//lithium metal battery in an embodiment of the present disclosure.

FIG. 5B illustrates the relationship between specific lithiation capacity and cycle number of each group of the negative electrode structures during the multiple charge and discharge cycles when different weight percentages of SPEEK-Li are used as the negative electrode coating layer in an embodiment of the present disclosure.

FIG. 6A illustrates the relationship between voltage and specific capacity of each group of the positive electrode structures with or without SPEEK-Li as the positive electrode coating layer at different charging current density in an embodiment of the present disclosure.

FIG. 6B illustrates the relationship between specific capacity and charging time of each group of the positive electrode structures with or without SPEEK-Li as the positive electrode coating layer in an embodiment of the present disclosure.

FIG. 6C illustrates the relationship between voltage and specific capacity of each group of the positive electrode structures with or without SPEEK-Li as the electrode coating layer at different discharging current density in an embodiment of the present disclosure.

FIG. 6D illustrates the relationship between capacity retention, coulombic efficiency and cycle number of each group of the positive electrode structures with or without SPEEK-Li as the positive electrode coating layer during multiple charge and discharge cycles in an embodiment of the present disclosure.

FIG. 7A and FIG. 7B illustrate the fields of view of a scanning electron microscope of each group of the positive electrode structures with or without SPEEK-Li as the positive electrode coating layer after multiple charge and discharge cycles in an embodiment of the present disclosure, in which FIG. 7A is the pristine positive electrode structure (pristine group), and FIG. 7B is the positive electrode structure including the positive electrode coating layers (coated group).

FIG. 8A illustrates the relationship between voltage and specific capacity of each group of the negative electrode structures with or without SPEEK-Li as the negative electrode coating layer at different charging current density in an embodiment of the present disclosure.

FIG. 8B illustrates the relationship between specific capacity and charging time of each group of the negative electrode structures with or without SPEEK-Li as the negative electrode coating layer in an embodiment of the present disclosure.

FIG. 8C illustrates the relationship between voltage and specific capacity of each group of the negative electrode structures with or without SPEEK-Li as the negative electrode coating layer at different discharging current density in an embodiment of the present disclosure.

FIG. 8D and FIG. 8E illustrate the relationship between specific capacity and cycle number of each group of the negative electrode structures with or without SPEEK-Li as the negative electrode coating layer during multiple charge and discharge cycles in an embodiment of the present disclosure, in which FIG. 8D refers to coated group and FIG. 8E refers to pristine group.

FIG. 9A and FIG. 9B illustrate the fields of view of a scanning electron microscope of each group of the negative electrode structures with or without SPEEK-Li as the negative electrode coating layer after multiple charge and discharge cycles in an embodiment of the present disclosure, in which FIG. 9A is the pristine negative electrode structure (pristine group), and FIG. 9B is the negative electrode structure including the negative electrode coating layers (coated group).

FIG. 10 illustrates the relationship between capacity retention ratio and cycle number of each group of the batteries during multiple charge and discharge cycles in an embodiment of the present disclosure, in which the batteries includes the NCM811//graphite battery without the coating layer on the electrodes (P-P group) and the NCM811//graphite battery that SPEEK-Li is used as the positive electrode coating layer and the negative electrode coating layer (C-C group) in an embodiment of the present disclosure.

### DETAILED DESCRIPTION

It is to be understood that different implementations or embodiments provided in the following may implement different features of the subject matter of the present disclosure. The embodiments of specific components and arrangements are used to simplify the disclosure and not to limit the disclosure. Of course, these are only examples and are not intended to be limiting. For example, the description below that the first feature is formed on the second feature includes the two being in direct contact, or there are other additional features between the two that are not in direct contact. Furthermore, the present disclosure may repeat reference numerals and/or symbols in the various embodiments. Such repetition is for simplicity and clarity and does not represent a relationship between the various embodiments and/or configurations discussed.

Terms used in this specification generally have their ordinary meanings in the art and in the context in which they are used. The embodiments used in this specification, including examples of any terms discussed herein, are illustrative only and do not limit the scope and meaning of the disclosure or any exemplified terms. Likewise, the present disclosure is not limited to some of the implementations provided in this specification.

It will be understood that, although the terms “first,” “second,” etc., may be used herein to describe various elements, these elements should not be limited by these terms. These terms are used to distinguish one element from another. For example, a first element could be termed a second element, and similarly, a second element could be termed a first element, without departing from the scope of the embodiments.

As used herein, the phrase “and/or” includes any and all combinations of one or more of the associated listed items.

As used herein, the terms “comprise,” “include,” “has,” etc. are to be understood as open-ended, that is, to mean including but not limited to.

Some embodiments of the present disclosure provide an electrode structure, including an electrode active material particle and an electrode coating layer. The electrode coating layer covers the positive electrode, in which the electrode coating layer includes a structure of formula 1,

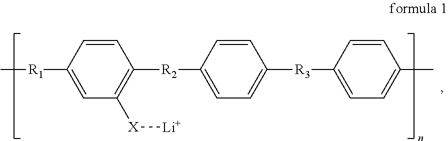

in which R₁ is oxygen, sulfur, ketone group or hydrocarbon group, R₂ is oxygen, sulfur, ketone group or hydrocarbon group, R₃ is oxygen, sulfur, ketone group or hydrocarbon group, and X is sulfonic acid group.

In some embodiments, the electrode structure can be a positive electrode structure or a negative electrode structure. When the electrode structure is served as the positive electrode structure, the electrode coating layer can be referred to as a positive electrode coating layer. When the electrode structure is served as the negative electrode structure, the electrode coating layer can be referred to as a negative electrode coating layer.

It can be understood that after multiple charge and discharge cycles, the positive electrode often cracks due to stress arising from crystal deformation of the crystal grains of the positive electrode active material particle, resulting in reduced capacity (capacitance) and reduced stability. As for the negative electrode, the problem that metal from cations in the electrolytic solution or solid impurities generated by the reaction in the electrolytic solution are formed on the negative electrode exists. As for of the electrode structure in the present disclosure, through the setting of the electrode coating layer, the abovementioned problems can be avoided, the battery capacity of charge and discharge can be increased, the activation energy for cation insertion can be reduced, the stability of the electrode structure can be improved, and the service life of the positive electrode can be extended. Additionally, the electrode coating layer can especially be applied to fast-charging battery that requires high current density. It should be emphasized that when the formula 1 is used as a coating layer material, it can achieve better protection for the electrode structure since the tri-phenyl ring structure of formula 1 has greater hardness.

In some embodiments, the electrode coating layer fills the gaps between the crystal grains of the electrode active material particle and serves as a buffer layer between the crystal grains of the electrode active material particle, further improving the protection of the electrode and improving the stability of the electrode.

In some embodiments, a weight percentage of the electrode coating layer is from 0.1% to 5% based on 100% by total weight percentage of the electrode active material particle and the electrode coating layer, such as 0.5%, 1%, 1.5%, 2%, 2.5%, 3%, 3.5%, 4%, 4.5%, 5% or any value in any of above-mentioned intervals. If the weight percentage of the electrode coating layer is too high, the capacity decreases. If the weight percentage of the electrode coating layer is too low, the protection effect is limited. In addition, when the weight percentage of the electrode coating layer is higher than 1% (such as 2% or 3%, etc.), the improvement effect of capacity is limited. In some embodiments, the electrode coating layer includes sulfonated poly(ether ether ketone)-lithium (Li-SPEEK or SPEEK-Li) and has a structure of formula 2:

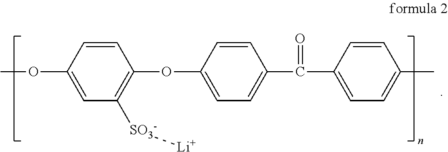

Compared with SPEEK without lithium ions or other polymers without tri-phenyl ring structure, Li-SPEEK can achieve larger maximum capacity and better charging efficiency.

In some embodiments, the electrode active material particle includes Li, Ni, Co, Mn, or a combination thereof, or includes graphite for serving as active ingredients. For example, the electrode active material particle is LiNi_{0.83}Co_{0.12}Mn_{0.05}O₂ (NCM 811) when the electrode structure serves as the positive electrode; the electrode active material particle is graphite when the electrode structure serves as the negative electrode.

In some embodiments, when the electrode structure serves as the positive electrode, the electrode structure further includes an electrode conductive additive (such as carbon black) and an electrode binder (or referred to as a positive electrode binder, such as polyvinylidene difluoride (PVDF)). In some embodiments, a total weight percentage of the electrode active material particle (such as Li, Ni, Co, and Mn) is from 70% to 99% based on 100% by weight percentage of the total weight percentage of the electrode active material particle and the electrode coating layer, such as 70%, 75%, 80%, 85%, 90%, 95%, 98%, 99%, or any value in any of above-mentioned intervals. If the weight percentage is too high, the possibility of internal cracking of the positive electrode is increased. If the weight percentage is too low, the capacity will decrease due to reduction of electrode conductivity caused by excessive binder materials. In some embodiments, a weight percentage of the electrode conductive additive is from 1% to 15% (such as 1%, 5%, 10%, 15% or any value in any of above-mentioned intervals) and a weight percentage of the electrode binder is from 1% to 15% (such as 1%, 5%, 10%, 15% or any value in any of above-mentioned intervals) based on 100% by weight percentage of the electrode active material particle and the electrode coating layer. If the weight percentage of the positive electrode binder is too low, the possibility of internal cracking of the positive electrode is increased. If the weight percentage of the electrode binder is too high, the capacity will decrease.

In some embodiments, when the electrode structure serves as the negative electrode, the electrode active material particle is a carbon material particle (such as graphite) and further includes an electrode binder (or referred to as a negative electrode binder, such as polyvinylidene difluoride (PVDF), carboxymethyl cellulose (CMC), styrene-butadiene rubber (SBR), and alginate). In some embodiments, a weight percentage of the carbon material is from 90% to 99% (such as 90%, 92%, 94%, 96%, 98%, 99%, or any value in any of above-mentioned intervals) and a weight percentage of the electrode binder is from 0.5% to 10% (such as 0.5%, 1.0%, 1.5%, 2.0%, 2.5%, 5%, 7.5%, 10% or any value in any of above-mentioned intervals) based on 100% by weight percentage of the electrode active material particle and the electrode coating layer. If the weight percentage of the electrode binder is too low, adhesion efficiency is limited. If the weight percentage of the electrode binder is too high, the capacity will decrease.

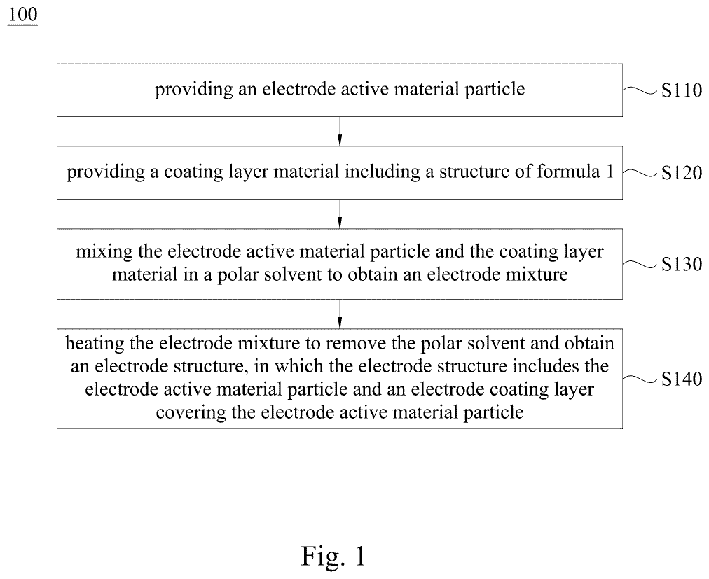

Furthermore, please refer to FIG. 1. A method 100 of manufacturing an electrode structure is provided, including: step S110, providing an electrode active material particle; step S120, providing a coating layer material, in which the coating layer material includes a structure of formula 1:

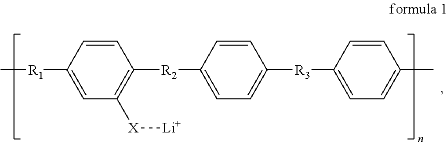

in which R₁ is oxygen, sulfur, ketone group or hydrocarbon group, R₂ is oxygen, sulfur, ketone group or hydrocarbon group, R₃ is oxygen, sulfur, ketone group or hydrocarbon group, and X is sulfonic acid group; step S130, mixing the electrode active material particle and the coating layer material in a polar solvent to obtain an electrode mixture; and step S140, heating the electrode mixture to remove the polar solvent and obtain an electrode structure, in which the electrode structure includes the electrode active material particle and an electrode coating layer covering the electrode active material particle.

In some embodiments, the electrode active material particle includes Li, Ni, Co, Mn, or a combination thereof, or includes graphite. The suitable materials can be selected depending on the condition that the electrode structure serves as the positive electrode or negative electrode. In some embodiments, the coating layer material includes sulfonated poly(ether ether ketone)-lithium (SPEEK-Li), having a structure of formula 2 as follows,

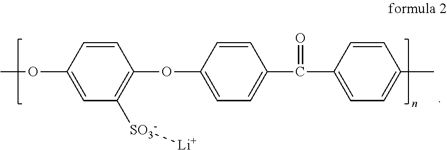

In some embodiments, step S130 of mixing the electrode active material particle and the coating layer material in the polar solvent includes mixing the electrode active material particle and the coating layer material in a weight ratio of from 95:5 to 99.9:0.1 (such as 95:5, 96:4, 97:3, 98:2, 99:1, 99.5:0.5, 99.9:0.1 or any value in any of above-mentioned intervals).

In some embodiments, the polar solvent includes N,N-dimethylacetamide (DMAc).

Some embodiments of the present disclosure provide a battery, including the abovementioned electrode structure, the another electrode structure and the electrolytic solution. The electrolytic solution electrically connects the electrode structure and the another electrode structure via ion conduction. Through the setting of the electrode coating layer including the structure of formula 1 in the electrode structure, the capacity, the charging efficiency and the stability of the battery can be increased, and the service life of the battery can be extended. Additionally, the electrode coating layer can even be applied to fast-charging batteries that require high current density. At the same time, if another electrode coating layer in another electrode structure also includes the structure of formula 1, the aforementioned effect can be further enhanced.

In some embodiments, when the electrode structure is disposed in the positive electrode, another electrode structure is disposed in the negative electrode (vice versa). For example, the electrode active material particle in the electrode structure includes Li, Ni, Co and Mn (such as NCM 811), and another electrode active material particle in another electrode structure includes a carbon material particle.

In some embodiments, another electrode structure includes another electrode active material particle and another electrode coating layer, another electrode coating layer covers another electrode active material particle, and another electrode coating layer further includes the structure of formula 1. Regarding the detailed materials, content values and specific functions of the electrode structure and another electrode structure here, further reference can be made to the relevant paragraphs of the aforementioned electrode structure, and will not be described again here.

In some embodiments, the electrolytic solution includes a lithium ion.

A series of examples of condition tests for the electrode structures and the batteries are provided below to specifically illustrate some embodiments of the present disclosure.

### Example 1—Manufacture of Electrode Structure

### 1. Coating Layer Material (Sulfonated Poly(Ether Ether Ketone)-Lithium, Li-SPEEK)

1 g of poly(ether ether ketone) (PEEK) was mixed with 19 ml of concentrated sulfuric acid (volume percentage concentration was 98%), and then they were reacted at 40° C. for at least 4 hrs. Next, excess ice water was added to sulfonate the polyether ether ketone into sulfonated poly(ether ether ketone) (SPEEK). Furthermore, SPEEK and 1M LiOH were reacted in an environment with a pH value of about 7, so that the sulfonic acid group in SPEEK further interacted with lithium ions to form ionic bonds, forming sulfonated poly(ether ether ketone)-lithium (Li-SPEEK, or SPEEK-Li) with the structure of the aforementioned formula 2.

### 2. Electrode Structure

In the NCM//graphite battery (lithium ion battery), there was a problem of cracking remained in the positive electrode (the electrode active material particle was NCM 811, LiNi_{0.83}Co_{0.12}Mn_{0.05}O₂) while the positive electrode was subjected to charing and discharging cycles. The cracking arises from lattice deformation of the small crystal grains that constitutes the large positive electrode active-material particles. In addition, there was a problem remained in the negative electrode that the lithium ions in the electrolytic solution could be easily electroplated on graphite.

In order to improve the aforementioned problems, an attempt was made to use Li-SPEEK as the electrode coating layers to cover the positive electrode and negative electrode, respectively. The detailed steps were as follows.

First of all, a positive electrode material (80 wt % NCM 811, 10 wt % carbon black and 10 wt % poly(vinylidene difluoride) was provided, in which NCM 811 served as the positive electrode active material particle, and poly(vinylidene difluoride) served as the positive electrode binder. A negative electrode material (90 wt % graphite, 5 wt % carbon black (product name was Super-P) and 5 wt % sodium alginate) was provided, in which graphite served as the negative electrode active material particle, sodium alginate served as the negative electrode binder. Furthermore, the covering layer solution (5 wt % Li-SPEEK dissolved in DMAc) was provided.

For positive electrode structure:

The electrode active material particle (NCM 811) was mixed with the covering layer solution (5 wt % Li-SPEEK dissolved in N,N-dimethylacetamide (DMAc)) to obtain the positive electrode mixture, in which the weight ratio of the electrode active material particle (NCM 811) and Li-SPEEK in the positive electrode material was 99:1.

Next, the positive electrode mixture was heated in a vacuum environment at 60° C. for 20 hrs to remove DMAc and obtain a positive electrode mixture having an electrode coating layer.

The positive electrode mixture was mixed with the carbon black and poly(vinylidene difluoride) to obtain a positive electrode structure, in which the positive electrode mixture (including the electrode active material particle and the electrode coating layer) is 80 wt %, carbon black (product name: Super-P), serving as an electrode conductive additive, was 10 wt %, and poly(vinylidene difluoride), serving as a positive electrode binder, was 10 wt % based on 100% by weight percentage of the positive electrode structure.

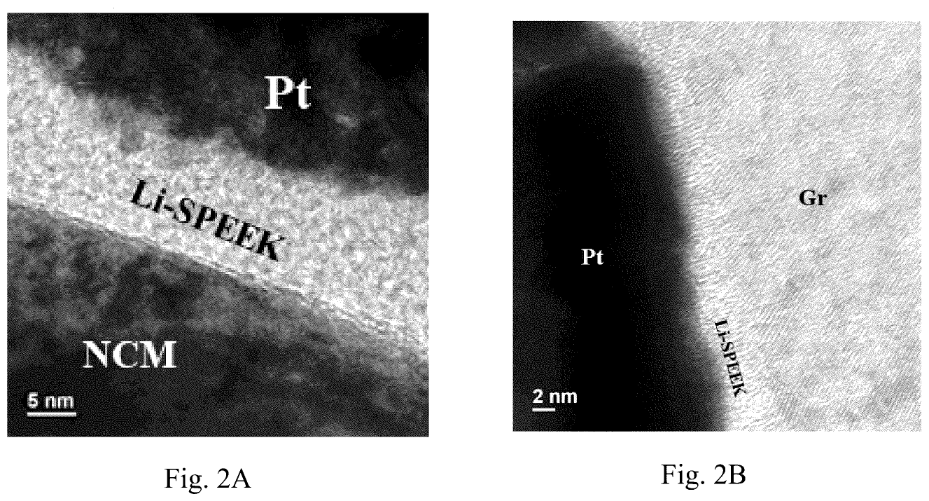

Next, the positive electrode structure was observed with a transmission electron microscope. The results were shown in FIG. 2A, in which platinum (Pt) was the metallic material placed on the surface of the positive electrode structure to assist observation as the positive electrode structure was manufactured as an electron microscope sample.

FIG. 2A represented that Li-SPEEK covered the surface of NCM 811 (abbreviated as NCM) and extensively filled in the gaps between NCM grains. Furthermore, although not shown in the figures, Li-SPEEK may further extend into the gaps between the grains of NCM under the microscopic observation.

For negative electrode structure:

The negative electrode structure was manufactured basically similar to the manufacture method of the positive electrode structure.

The difference between the manufacture process of the negative electrode structure and the positive electrode structure was that graphite was selected for serving as the electrode active material particle of the negative electrode structure, and sodium alginate was selected for serving as the negative electrode binder, in which the negative electrode mixture (including the electrode active material particle and the electrode coating layer) was 90 wt %, carbon black, used as the electrode conductive additive, was 5 wt %, polyvinylidene fluoride, used as the negative electrode binder, was 5 wt % based on 100 wt % by weight of the negative electrode structure.

After obtaining the negative electrode structure, the negative electrode structure was observed with the transmission electron microscope. The result was shown in FIG. 2B.

FIG. 2B represented that Li-SPEEK covered the surface of graphite (Gr).

Furthermore, according to the scale of FIG. 2A and FIG. 2B, it could be observed that the thickness of Li-SPEEK (electrode coating layer or another electrode coating layer) was from 1 nm to 20 nm.

### Example 2—Protective Effect of Coating Layer on Electrodes

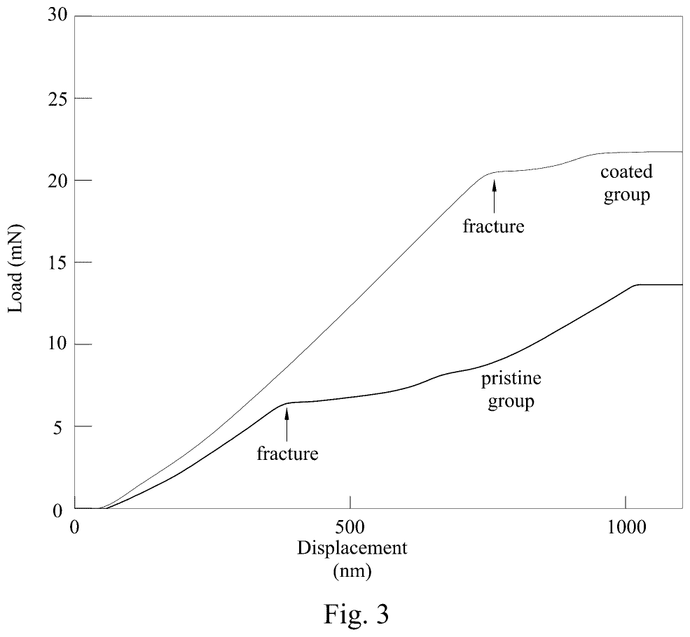

In order to test whether the coating layer had a protective effect for the electrodes, an indentation test was further performed on the positive electrode structure containing the Li-SPEEK coating layer. The principle of the indentation test was to use an indenter tip to continuously apply force to the surface of the positive electrode structure, and detect the relationship between the load carried by a specific point on the surface and the vertical displacement of that point. The result was shown in FIG. 3, in which the coated group was the positive electrode structure including the Li-SPEEK coating layer and the positive electrode, and the pristine group was the positive electrode structure only including the positive electrode.

FIG. 3 represented that comparing with the pristine group without any coating layer, the coated group withstood greater pressure, performed lower deformation amplitude, and had better mechanical strength since the Li-SPEEK coating layer was covered on the positive electrode. It was also worth emphasizing that Li-SPEEK was harder than other polymers without phenyl rings since Li-SPEEK had three phenyl rings.

### Example 3—Comparison of Electrochemical Performance Between Electrode Structures with Different Coating Layer Materials

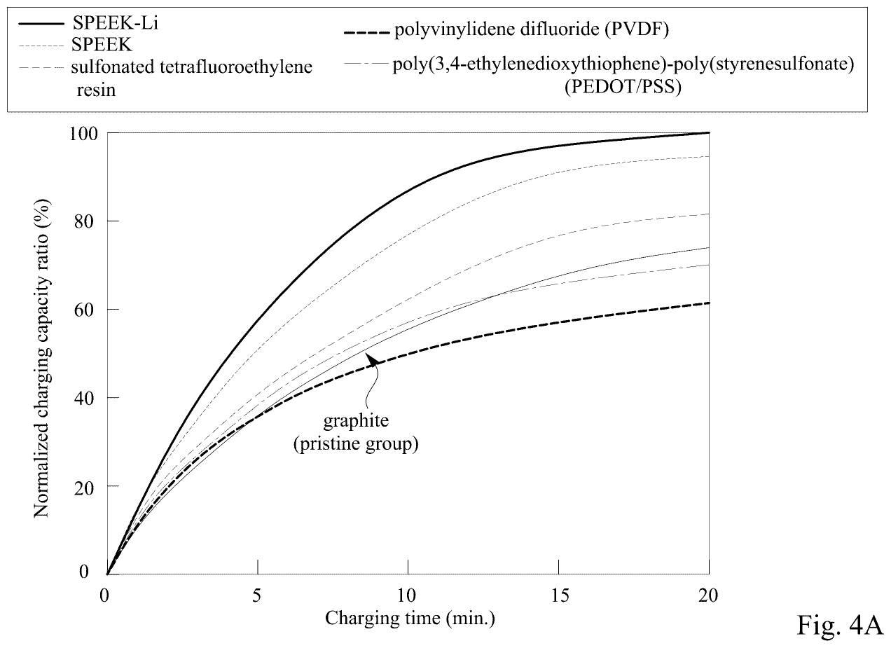

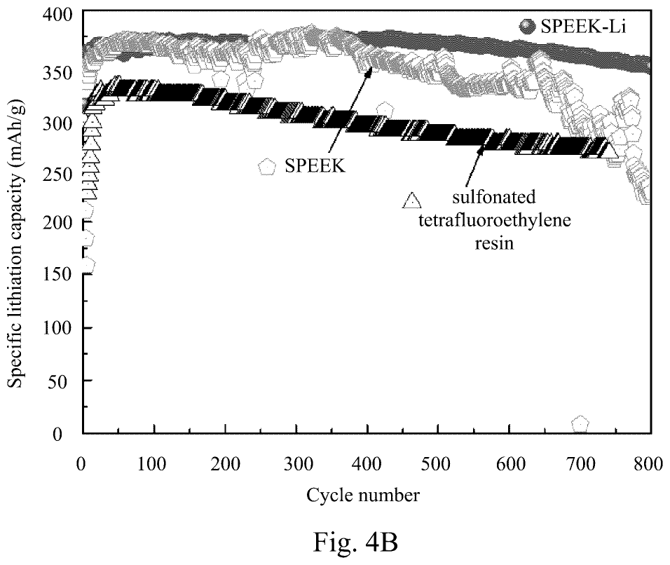

To compare the differences of electrochemical performance between the coating layers manufactured in Example 1 (Li-SPEEK) and the coating layers manufactured from other materials, the negative electrode structures with different negative electrode coating layers were manufactured by the method similar to Point 2 of Example 1, in which the different negative electrode coating layers had the same weight percentage but respectively had a coating layer material A (SPEEK), a coating layer material B (sulfonated tetrafluoroethylene resin), a coating layer material C (polyvinylidene difluoride, PVDF), or a coating layer material D (poly(3,4-ethylenedioxythiophene)-poly(styrenesulfonate), PEDOT/PSS). Each group of the negative electrode structures was paired with the same positive electrode, and the fast charging test and stability test were performed at the current density for fast charging (10C, fully charged in 6 minutes) under a CC-CV charging operation protocol. The results were shown in FIG. 4A (the vertical axis was obtained by normalizing the capacity data of each group, in which the highest capacity of the SPEEK-Li group was used as the standard of 100) and FIG. 4B.

FIG. 4A represented that the coating efficiency of the PVDF group and the PEDOT/PSS group were not satisfactory. Within 15 minutes, the capacity of both groups did not increase significantly, and the capacity of the PVDF group was even lower than that of the pristine group (without the coating layer). Relatively, the capacity of the SPEEK group and the sulfonated tetrafluoroethylene resin group were significantly improved. However, the capacity of each group of the coating layer material group A to the coating layer material group D (SPEEK, sulfonated tetrafluoroethylene resin, PVDF and PEDOT/PSS) was lower than the SPEEK-Li group used in Example 1.

Furthermore, the SPEEK group, the sulfonated tetrafluoroethylene resin group and the SPEEK-Li group in Example 1 were subsequently subjected to long-term rapid charging and discharge stability tests. The results were shown in FIG. 4B.

FIG. 4B represented that comparing with the SPEEK group and the sulfonated tetrafluoroethylene resin group, the capacity of the SPEEK-Li group was still stably maintained at the highest value relatively and the SPEEK-Li group had the best stability after multiple charge and discharge tests.

Therefore, compared with the polymers (SPEEK, sulfonated tetrafluoroethylene resin, PVDF and PEDOT/PSS) selected from the coating layer material A group to the coating layer material D group, the electrode structure with SPEEK-Li as the coating layer represented better fast-charging property and cycle stability under fast charging.

### Example 4—Comparison of Electrochemical Performance Between Electrode Structures with Different SPEEK-Li Contents

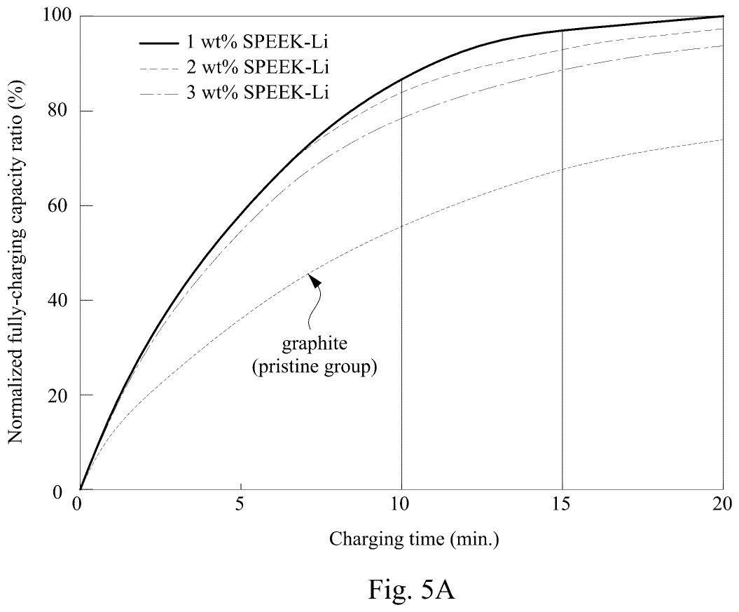

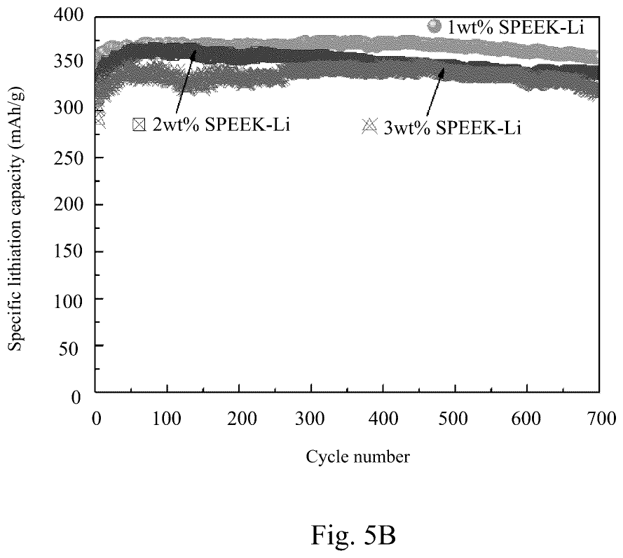

To test whether different SPEEK-Li contents affected the electrochemical performance of the electrode structures, the negative electrode structures with different weight percentages of SPEEK-Li were manufactured by the method similar to Point 2 of Example 1 (the weight percentage here represented the weight percentage of SPEEK-Li in the sum of the negative electrode active material particle and SPEEK-Li). Each group of the negative electrode structures was paired with lithium metal counter electrode, and the fast charging test and stability test were performed at the current density for fast charging (10C). The results were shown in FIG. 5A (the vertical axis was obtained by normalizing the capacity data of each group, in which the highest capacity of the 1 wt % SPEEK-Li group was used as the standard of 100) and FIG. 5B.

FIG. 5A represented that as the increase of the SPEEK-Li (the 2 wt % SPEEK-Li group and the 3 wt % SPEEK-Li group), the capacity decreased slightly. The 1 wt % SPEEK-Li group represented a better capacity curve (higher maximum capacity ratio).

Further, the 2 wt % SPEEK-Li group, the 3 wt % SPEEK-Li group and the 1 wt % SPEEK-Li group in Example 1 were subsequently subjected to a long-term fast charging stability test. The results were shown in FIG. 5B.

FIG. 5B represented that any group of the 1 wt % SPEEK-Li group, the 2 wt % SPEEK-Li group and the 3 wt % SPEEK-Li group showed good stability.

After comprehensive consideration of FIG. 5A and the cost aspect, the 1 wt % SPEEK-Li group was subsequently selected as the coating layer condition. The electrochemical tests focused on the positive electrode structure with the positive electrode coating layer, the negative electrode structure with the negative electrode coating layer and the battery with the positive electrode coating layer and negative electrode coating layer were further conducted, and the appearances of the positive electrode structure and the negative electrode structure under the electron microscope after multiple charges and discharges were observed.

### Example 5—Electrochemical Properties of Lithium Ion Battery with Positive Electrode Coating Layer of SPEEK-Li

To test whether SPEEK-Li affected the electrochemical performance of the positive electrode structure when SPEEK-Li was used as the positive electrode coating layer, a half-cell test for the positive electrode structure (the positive electrode coating layer: SPEEK-Li, the positive electrode: NCM811 (represented by the electrode active material particle)) manufactured by Example 1 was performed and a series of electrochemical properties were conducted. The counter electrode in the half-cell test was lithium metal, and the electrolytic solution included lithium ions.

### 5.1. Charging Test

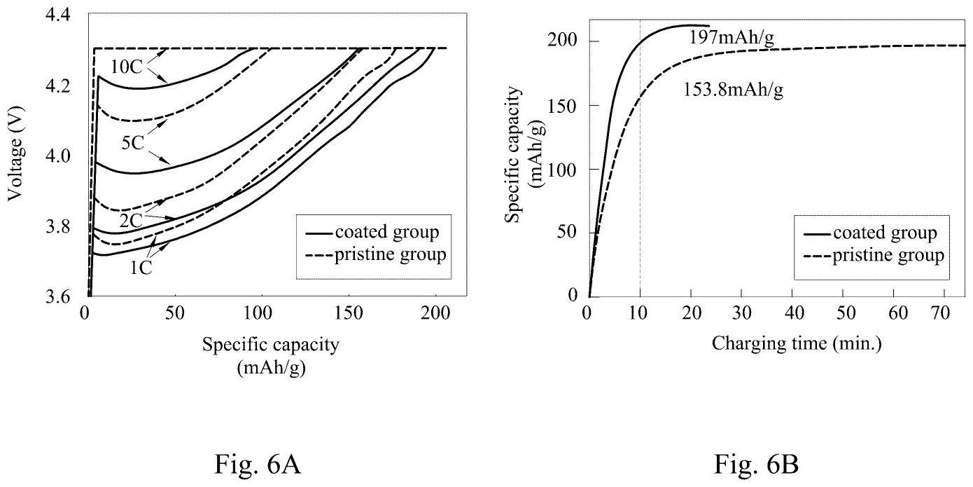

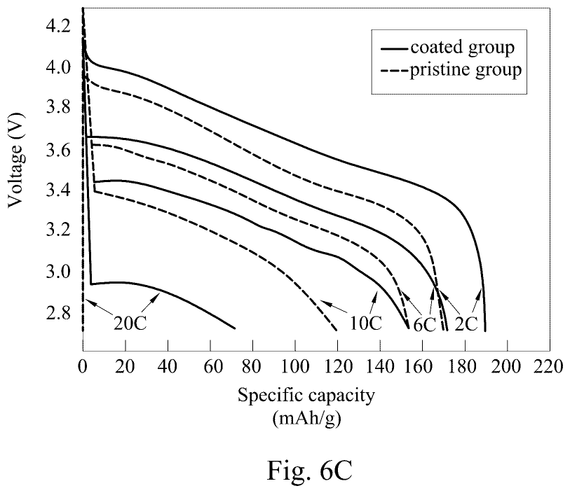

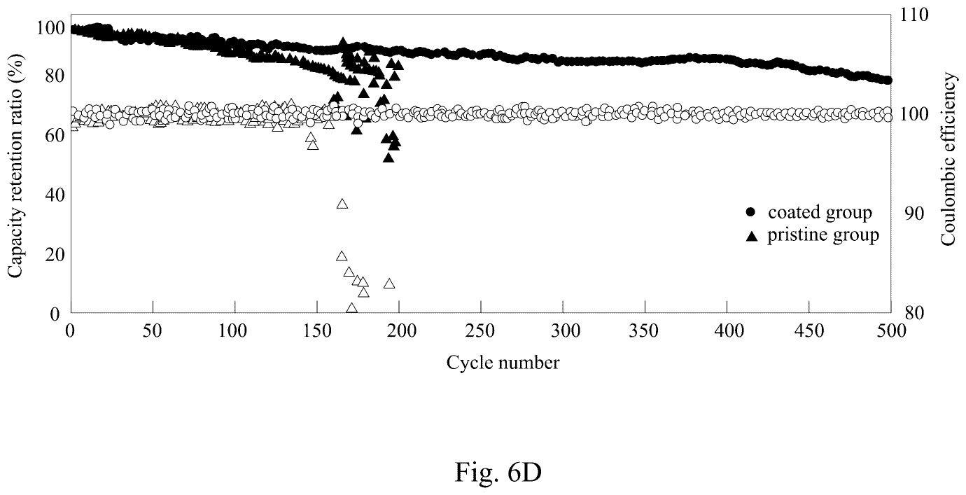

First of all, each of the positive electrode structures was divided into the groups with different current densities (1C group, 2C group, 5C group, 10C and group, in which 1C group represented that the battery could be fully charged in 1 hr with the selected current density, 2C group represented that the battery could be fully charged in 1/2 hr with the selected current density, and so on). The positive electrode structures were discharged to 2.8V with the current density of 0.1C, following by charging the positive electrode structures under a constant-current (CC)—constant voltage (CV) protocol from 2.8V to 4.3V, and then the relationship between voltage and specific capacity of each group of the positive electrode structures was observed during charging. The results were shown in FIG. 6A.

FIG. 6A represented that compared with the pristine group, a lower voltage was required for the coated group to start charging (less resistance increased since the current is constant), and the coated group achieved a larger specific capacity when both groups were charging with the same current density. The aforementioned tendency applied to the current density groups charged at different rates.

Furthermore, the relationship between specific capacity and charging time was tested under a CC-CV charging operation protocol when the positive electrode structures were fast charged with the same current density of 10C. The results were shown in FIG. 6B.

FIG. 6B represented that compared with the pristine group, the coated group could be charged to a higher specific capacity within the same period of time (for example, 10 minutes) and achieve a higher maximum specific capacity (the coated group: 197 mAh/g, the pristine group: 153.8 mAh/g).

### 5.2. Discharging Test

As stated in the above-mentioned Point 5.1, the constant-current discharging (CC-discharging) test was performed with different current density. Each group was charged to 4.3V with the current density of 0.1C prior to a discharging test, following by discharging from 4.3V to 2.8V, and then the relationship between voltage and specific capacity of each group during discharging was observed. The results were shown in FIG. 6C.

FIG. 6C represented that compared with the pristine group, the coated group could release a higher specific capacity and achieve a lower voltage decrease (the decrease of the resistance was lower at constant current) during discharge when discharging with the same current density. The aforementioned tendency applied to the current density groups discharged at different rates.

Furthermore, as stated on the above-mentioned charge and discharge tests of Point 5.1. and Point 5.2. and collaboratively through AC impedance analysis, the activation energies of charge-transfer of the coated group and the pristine group, 15.13 KJ/mol and 79.4 KJ/mol respectively, were obtained. The activation energy of the coated group was much lower than that of the pristine group, indicating that the reaction energy required for the coated group was lower than that required for the pristine group, and the electrochemical reaction of the coated group could be performed more easily.

### 5.3. Stability Test

To test the stability of the electrode structures, the multiple charge and discharge cycles were performed in the pristine group and the coated group, and the relationship between capacity retention (percentage of real-time capacity relative to maximum capacity) and coulombic efficiency of each group during different cycle number was observed, in which capacity retention was shown as solid dot and coulombic efficiency was shown as hollow dot. The results were shown in FIG. 6D.

FIG. 6D represented that after the 150th cycle, the capacity and the coulombic efficiency of the pristine group decreased rapidly. Relatively, the capacity retention ratio of the coated group was maintained at 82% and the coulombic efficiency of the coated group was maintained at 100% during the 500th cycle. Therefore, compared with the pristine group, the stability of the coated group was significantly better.

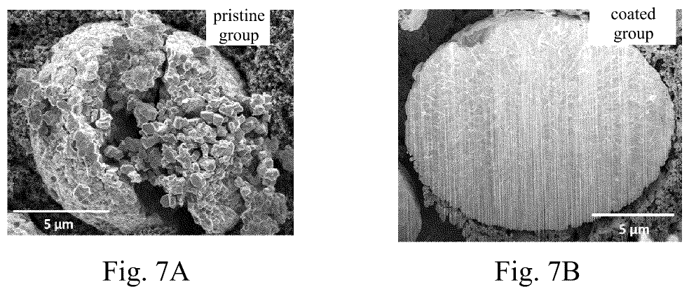

Furthermore, the positive electrode structures were observed by the scanning electron microscope after finishing the charge and discharge cycles. The results were shown in FIG. 7A to FIG. 7B, in which FIG. 7A was the positive electrode structure of the pristine group, and FIG. 7B was the positive electrode structure of the coated group.

It could be understood that the force, caused by arrangement difference between grains, was accumulated along grain boundaries since smaller crystal grains constitutes the electrode active material particles of the positive electrode.

FIG. 7A represented that internal cracking of the positive electrode of the pristine group happened after multiple charge and discharge cycles. Relatively, FIG. 7B represented that the positive electrode structure of the coated group kept intact after multiple charge and discharge cycles due to the existence of the positive electrode coating layer (extending and filling in the gaps of grains of the electrode active material particles to strengthen their mechanical integrity of the positive electrode).

### Example 6—Electrochemical Property of Lithium Ion Battery Including the Negative Electrode Coating Layer of SPEEK-Li

To test whether SPEEK-Li affected the electrochemical performance of the negative electrode structure when SPEEK-Li was used as the negative electrode coating layer, a half-cell test for the negative electrode structure (the negative electrode coating layer: SPEEK-Li, the negative electrode: graphite (represented by the electrode active material particle)) manufactured by Example 1 was performed and a series of electrochemical properties were conducted. The reference electrode in the half-cell test was lithium metal, and the electrolytic solution included lithium ions.

### 6.1. Charging (Defined as Lithiation for Negative Electrode Active Materials) Test

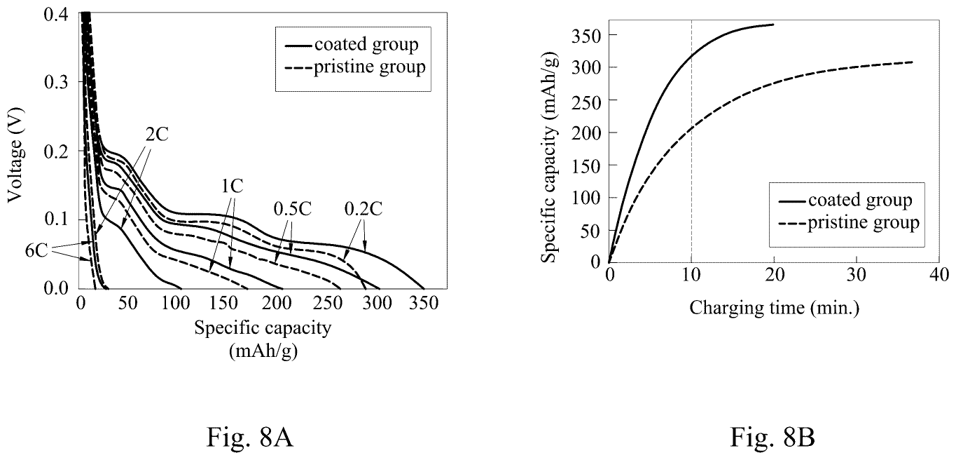

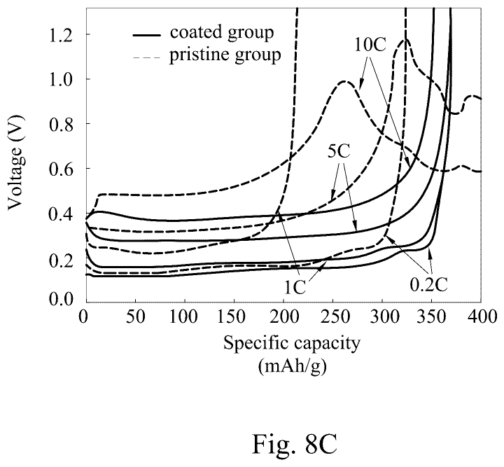

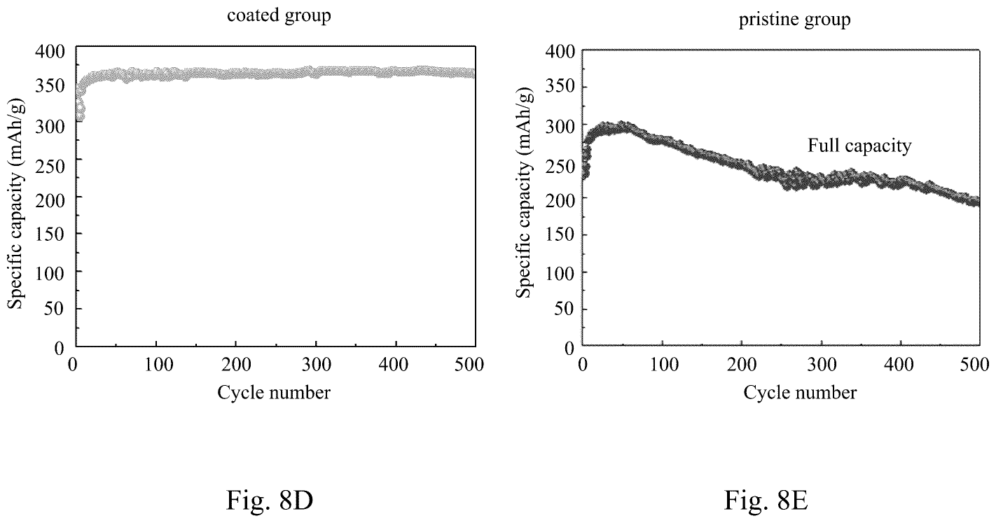

First of all, each of the negative electrode structures was divided into the groups with different current densities, and the negative electrode structures were discharged to 2.0V with the current density of 0.1C (calculated based on the specific capacity of 372 mAh/g for graphite), following by charging the negative electrode structures under a CC-CV protocol from 2.0V to 0V, and then the relationship between voltage and specific capacity of each group of the negative electrode structures during charging was observed. The results were shown in FIG. 8A.

FIG. 8A represented that compared with the pristine group, lower polarization (less voltage change) was required for the coated group to achieve a larger specific capacity when both groups were charged with the same current density. The aforementioned tendency applied to the current density groups charged at different rates.

Furthermore, the charging efficiency of each group was tested after 100 times of charge and discharge cycles. The results were shown in FIG. 8B.

FIG. 8B represented that compared with the pristine group, the coated group could be charged to a higher specific capacity within the same period of time (for example, 10 minutes) and achieve a higher maximum specific capacity after 100 times of charge and discharge cycles.

In addition, it should be supplemented that compared with the specific capacity of the first charge for 10 minutes and the maximum specific capacity of the first charge (not shown in figures), the capacity of the coated group was maintained more than 80% and the maximum specific capacity of the coated group was maintained more than 65% after 500 times of charge and discharge cycles during the test.

### 6.2. Discharging (Defined as Delithiation for Negative Electrode Active Materials) Test

As stated on the above-mentioned the charging test at Point 6.1, the discharging test was performed according to the grouping of current density similar to the charging test of Point 6.1. Each group was charged to 0.0V with the current density of 0.1C prior to a discharging test, followed by discharging from 0.0V to 2.0V, and then the relationship between voltage and specific capacity of each group during discharging was observed. The results were shown in FIG. 8C.

FIG. 8C represented that when discharging with a higher current density (such as 5C or 10C), lithium in the pristine group was electroplated on the negative electrode, causing the specific capacity to change irregularly. Relatively, the situation that the specific capacity changed irregularly didn't happen in the coated group. Furthermore, even when we observed the 0.2C group or the 1C group whose specific capacity changed regularly, the coated group released a larger specific capacity during discharge compared with the pristine group.

Furthermore, as stated on the above-mentioned charge and discharge tests of Point 6.1. and Point 6.2. and collaboratively through AC impedance analysis, the activation energies of charge-transfer of the coated group and the pristine group, 24.4 KJ/mol and 67.0 KJ/mol respectively, were obtained. The activation energy of the coated group was much lower than that of the pristine group, indicating that the reaction energy required for the coated group was lower than that required for the pristine group, and the electrochemical reaction of the coated group could be performed more easily.

### 6.3. Stability Test

To test the stability of the negative electrode structures, the multiple charge and discharge cycles were performed in the pristine group and the coated group, and the specific capacity of each group at different cycle number was observed. The results were shown in FIG. 8D (the coated group) and FIG. 8E (pristine group).

FIG. 8D and FIG. 8E represented that after the 500th cycle, the specific capacity of the pristine group decreased by 35%. Relatively, the specific capacity of the coated group was almost no decrease after the 500th cycle. Therefore, compared with the pristine group, the stability of the coated group was significantly better.

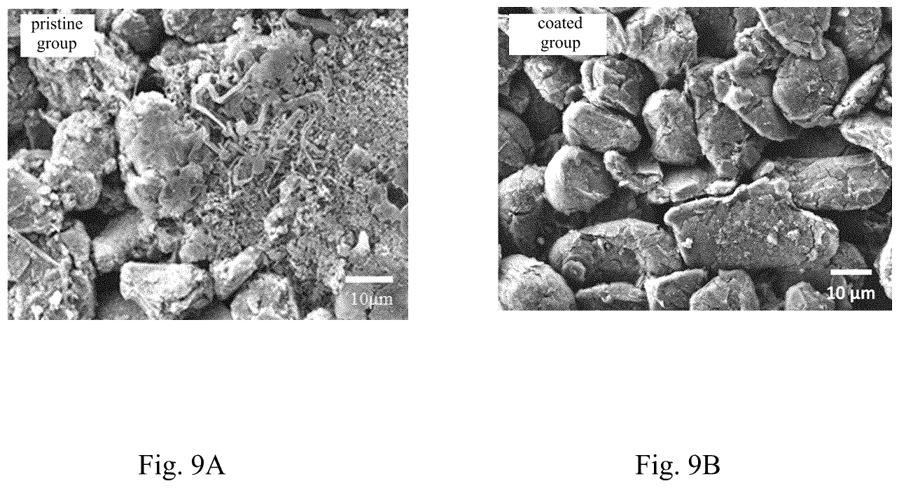

Furthermore, the negative electrode structures were observed by the scanning electron microscope after finishing the charge and discharge cycles. The results were shown in FIG. 9A and FIG. 9B, in which FIG. 9A was the negative electrode structure of the pristine group, and FIG. 9B was the negative electrode structure of the coated group.

FIG. 9A and FIG. 9B represented that in the pristine group, it was observed that lithium metal was electroplated on the outside of the negative electrode, and a tree-like solid electrolyte interphase (SEI; usually produced by the reaction of the electrolytic solution) surrounded the lithium metal generated by electroplating. The phenomena caused loss of capacity. Relatively, the coated group avoided the above phenomena due to the isolation provided by the negative electrode coating layer. Therefore, the design of the negative coating layer avoided the solid impurities produced by the reaction of the electrolytic solution and avoided the formation of lithium metal on the surface of the negative electrode, thereby avoiding the capacity loss of the negative electrode.

### Example 7—Electrochemical Property when Coating Layer of SPEEK-Li was Disposed on Different Electrodes

To test whether SPEEK-Li affected the electrochemical performance of the battery when SPEEK-Li was used as both of the positive electrode coating layer and the negative electrode coating layer at the same time, the NCM811//graphite lithium ion battery (C-C group, the coated group) was manufactured by the positive electrode structure (the positive electrode coating layer: SPEEK-Li, the positive electrode: NCM811 (represented by the electrode active material particle)), the negative electrode structure (negative electrode coating layer: SPEEK-Li, the negative electrode: graphite (represented by the electrode active material particle)) and the electrolytic solution including lithium ion manufactured in Example 1 together. Furthermore, a stability test was performed to compare the C-C group and the P-P group (without any coating layer, the pristine group).

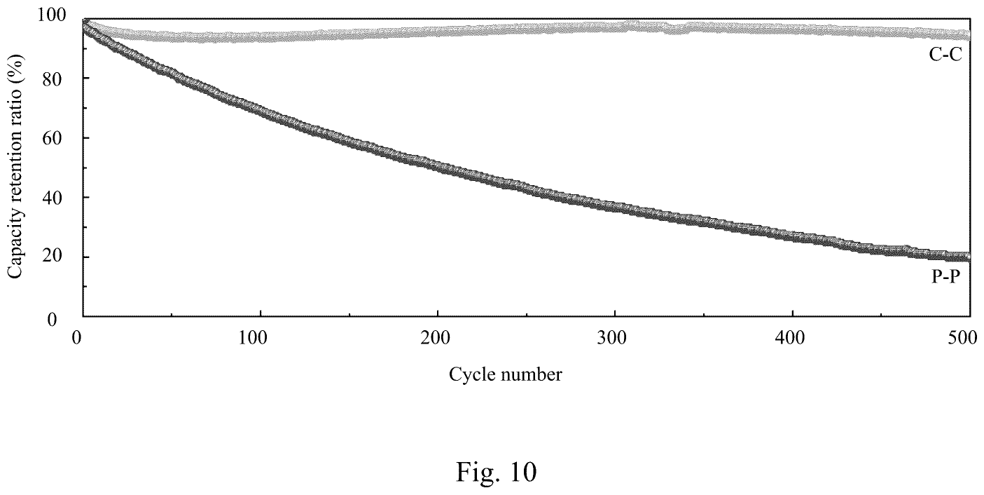

To test the stability of the batteries, the multiple charge and discharge cycles in the pristine group and the coated group were performed, and the relationship between capacity retention ratio (percentage of real-time capacity relative to maximum capacity) and cycle numbers of each group was observed. The results were shown in FIG. 10.

FIG. 10 represented that compared with the P-P group, the C-C group with the SPEEK-Li coating layers disposed on both electrodes performed the higher capacity retention, in which the C-C group performed the higher capacity retention (higher than 90%) even after the 500th cycle.

Although this disclosure has been described in detail with respect to certain embodiments, other embodiments are possible. Accordingly, the spirit and scope of the appended claims should not be limited to the embodiments described herein.

What is claimed is:

1. A electrode structure, comprising:
an electrode active material particle; and
an electrode coating layer, covering the electrode active material particle, wherein the electrode coating layer comprises a structure of formula 1, 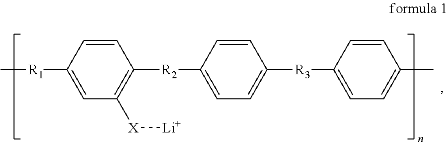
wherein R₁ is oxygen, sulfur, ketone group or hydrocarbon group, R₂ is oxygen, sulfur, ketone group or hydrocarbon group, R₃ is oxygen, sulfur, ketone group or hydrocarbon group, and X is sulfonic acid group.

2. The electrode structure of claim 1, wherein a weight percentage of the electrode coating layer is from 0.1% to 5% based on 100% by a total weight percentage of the electrode active material particle and the electrode coating layer.

3. The electrode structure of claim 1, wherein the electrode active material particle comprises Li, Ni, Co, Mn, or a combination thereof, or comprises graphite.

4. The electrode structure of claim 3, wherein a total weight percentage of Li, Ni, Co, Mn, or a combination thereof is from 70% to 99% based on 100% by weight percentage of the electrode active material particle and the electrode coating layer.

5. The electrode structure of claim 1, wherein the electrode structure further comprises an electrode conductive additive and an electrode binder.

6. The electrode structure of claim 5, a weight percentage of the electrode conductive additive is from 1% to 15% and a weight percentage of the electrode binder is from 1% to 15% based on 100% by weight percentage of the electrode active material particle and the electrode coating layer.

7. The electrode structure of claim 1, wherein the electrode coating layer comprises a structure of formula 2 as follows:

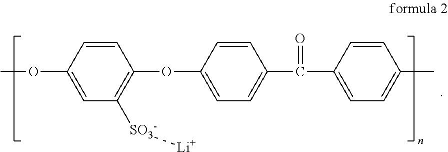

8. A battery, comprising:
the electrode structure of claim 1;
another electrode structure; and
an electrolytic solution, electrically connecting the electrode structure and the another electrode structure.

9. The battery of claim 8, wherein the another electrode structure comprises:
another electrode active material particle; and
another electrode coating layer, covering the another electrode active material particle, wherein the another electrode coating layer comprises the structure of formula 1.

10. The battery of claim 9, wherein a weight percentage of the another electrode coating layer is from 0.1% to 5% based on 100% by total weight percentage of the electrode active material particle and the another electrode coating layer.

11. The battery of claim 9, wherein the electrode active material particle in the electrode structure comprises Li, Ni, Co, Mn, or a combination thereof, and the another electrode active material particle comprises a carbon material particle.

12. The battery of claim 11, wherein a weight percentage of the carbon material particle is from 70% to 99% based on 100% by weight percentage of the another electrode active material particle and the another electrode coating layer.

13. The battery of claim 11, wherein the carbon material particle comprises graphite.

14. The battery of claim 11, the another electrode structure further comprises another electrode conductive additive and another electrode binder.

15. The battery of claim 14, a weight percentage of the another electrode conductive additive is from 1% to 15% and a weight percentage of the another electrode binder is from 1% to 15% based on 100% by weight percentage of the another electrode active material particle and the another electrode coating layer.

16. The battery of claim 8, wherein the electrolytic solution comprises a lithium ion.

17. A method of manufacturing an electrode structure, comprising:
providing an electrode active material particle;
providing a coating layer material, wherein the coating layer material comprises a structure of formula 1: 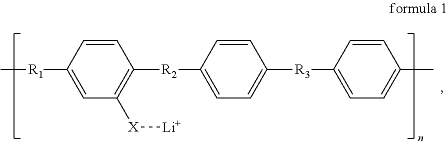
wherein R₁ is oxygen, sulfur, ketone group or hydrocarbon group, R₂ is oxygen, sulfur, ketone group or hydrocarbon group, R₃ is oxygen, sulfur, ketone group or hydrocarbon group, and X is sulfonic acid group;
mixing the electrode active material particle and the coating layer material in a polar solvent to obtain an electrode mixture; and
heating the electrode mixture to remove the polar solvent and obtain an electrode structure, wherein the electrode structure comprises an electrode active material particle and an electrode coating layer covering the electrode active material particle.

18. The method of claim 17, wherein the step of mixing the electrode active material particle and the coating layer material in the polar solvent comprises mixing the electrode active material particle and the coating layer material in a weight ratio of from 95:5 to 99.9:0.1.

19. The method of claim 17, wherein the coating layer material comprises a structure of formula 2 as follows,

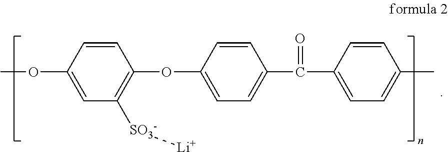

20. The method of claim 17, wherein the polar solvent comprises N,N-dimethylacetamide.
